(19) United States
(12) Patent Application Publication
(10) Pub. No.: US 2005/0223100 A1
(43) Pub. Date: Oct. 6, 2005

(54) Rendering a first media type content on a browser

(75) Inventors: Meng-Cheng Chen, Taipei (TW); Jeng-Chun Chen, Taipei (TW); Wei-Cheng Lin, Taipei (TW)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., 5621 BA Eindhoven (NL)

(21) Appl. No.: 10/514,292

(22) PCT Filed: May 7, 2003
(86) PCT No.: PCT/IB03/01918

§ 371 Date: Nov. 12, 2004

(30) Foreign Application Priority Data
May 17, 2002 (EP) 02076944.4

(51) Int. Cl. G06F 15/16

(52) U.S. Cl. 709/228; 709/229

(57) ABSTRACT

A method, a system and a client of/for rendering a first media type (11) content on a browser (10) on a client (16) with a rendering support from a server (13). The method includes the steps of determining if the first media type content is not suitable for being rendered due to limited resources on the client, and, if this is the case activating a first software component (12) prepared for handling and receiving rendering support from the server, sending, from the client, a link to the first media type content with a request for rendering support; determining, on the server, a second media type content of the received link, wherein the second media type content is suitable for being rendered on the client; transferring the second media type content to the client; and rendering, by the first software component, the second media type content. The method further includes the steps of receiving, by the first software component, a first input event; sending the first input event from the first software component to a second software component (15) on the server; transforming, by the second software component, the received first input event to a third media type content based on the first input event and the second media type content; transferring, by the second software component, the third media type content to the first software component; and rendering the third media type content. This enables for rendering of media types on the browser on the client that the browser was not initially suitable for or did not have system resources for.

This invention relates to a method of rendering a first media type content on a browser on a client with a rendering support from a server.

The present invention also relates to a computer system for performing the method.

The present invention further relates to a computer program product for performing the method.

Additionally, the present invention relates to a client for rendering a first media type content on a browser with a rendering support from a server.

EP 0,965.914 discloses an embodiment of a method for displaying mark-up language documents on a client. An HTML document is received and from that a corresponding program is generated outside the client and is subsequently transmitted for usage on the client to display said documents.

It is known that a browser on a thin client needs to perform a conversion of image content received to fit the smaller display size and resolution of said client, since the image content is typically originally designed to be displayed on the screen of a personal computer. It is a problem that the conversion of image content requires a large amount of computation power, memory space, etc, since thin clients are typically designed with a minimum of system resources in order to make them smaller and inexpensive compared to the personal computer.

The above prior art method involves the problem that the received program for displaying mark-up language documents on the client requires many system resources.

It is therefore an object of the present invention to provide rendering of image content and other displayable content to the browser on the client with minimum use of computation power and memory space in the client.

The above problem is solved by the method mentioned in the opening paragraph, when said method comprises the steps of:
determining if the first media type content is not suitable for being rendered due to limited resources on the client and, if this is the case, activating a first software component prepared for handling and receiving rendering support from the server;
transmitting, from the client, a link to the first media type content with a request for rendering support to the server;
determining, on the server, a second media type content of the received link, wherein the second media type content is suitable for being rendered on the client;
transferring, from the server, the second media type content to the client, in response to the received link and the request; and
rendering, by the first software component, the second media type content in response to the received second media type content.

In the first step, it may be determined that media type content is not suitable for being rendered due to limited resources on the client, and, subsequently said first software component is activated. It is activated on the client side to be prepared for the handling and the reception of subsequent rendering support from the server.

Secondly, the client requests support from the server. In the request for support, said link links to the content—that was not suitable for rendering in the browser of the client in the first step—may be included.

In the following three steps, the server retrieves the content of the link and subsequent converts it to a format and a content (the second media type content) which then is transferred to the client and subsequently rendered on the client.

The object of providing rendering of image content and other displayable content to the browser on the client is then achieved, since the conversion (step three) takes place on the server, thus the browser on the client needs only a minimum of computation power to render in the format of said second media type.

It is therefore an advantage of the invention that said steps of the method for accessing web sites on the client is transparent to the user since the user of the client will not notice that the client requests and obtains rendering support from the server. The steps of the method are also transparent to the user when no rendering support is obtained, since the rendering in this case takes place only on the client.

It is therefore a further advantage of the invention that in both ways of rendering—in the first place, from an initially, renderable format or, alternatively, in the second place, from a format converted to a rendereable format—the user will not experience any annoying difference between said two ways of rendering.

In another preferred embodiment of the invention, the method further comprises the steps of:
receiving, by the first software component, a first input event;
transmitting the first input event from the first software component to a second software component on the server,
transforming, by the second software component, the received first input event to a third media type content based on the first input event and the second media type content;
transferring, by the second software component, the third media type content to the first software component; and
rendering, by the first software component, the third media type content further in response to the received third media type content.

Corresponding to the initial, first five steps, these last five steps render to the client display—again with rendering support from the server—based on various inputs from a mouse, a keyboard, etc., on the client.

In step one and two these inputs (by means of one or more of said first input event(s)) are received by the server, which then—again—converts the input to a format and a content (said the third media type content), which are then transferred and subsequently rendered on the client.

In a preferred embodiment of the invention said step of determining if the first media type content is not suitable, etc. comprises:
determining, by the browser, that the first media type content is not renderable on the client; and
activating, if this is the case, the first software component by the browser.

In these steps, the browser, firstly determines that the current content is not suitable for being rendered and then, secondly the first software component is activated by the browser. Said first software component is activated to prepare for the handling and prepare for the reception of the subsequent rendering support from the server.

In another preferred embodiment of the invention said step of transmitting from the client, a link, etc comprises:
transferring, by the first software component, the link to the first media type content and the request to an application manager in the server; and
creating, by the application manager, the second software component as a plug-in application in response to the received link and request.

In the first step said link and request are sent to the application manager in the server; which then creates said second software component as a plug-in application to the server.

Hereby, the first and second software components on the client and the server, respectively, are now setup to perform and enable an end-to-end client/server architecture, and a subsequent communication between them.

In another preferred embodiment of the invention said step of determining, on the server, a second media type content of the received link comprises:
receiving, by the second software component, a first media type content based on the received link; and
converting, by the second software component, the first media type content to a second media type content.

In the first step, the received link (e.g. a full URL) may inform the server on which (other) server the content linked to can be found, and the server may subsequently retrieve said first media type content. In the final step, said first media type content may then be converted to said second media type content, which may then be rendered on the client, if received.

Previously mentioned problem is further solved by a client for rendering a first media type content on a browser with a rendering support from a server, said client comprising:
means for determining if the first media type content is not suitable for being rendered due to limited resources and, if this is the case, activating a first software component prepared for handling and receiving rendering support from the server;
means for transmitting a link to the first media type content with a request for rendering support to the server;
means for receiving a second media type content of the transmitted link, wherein the second media type content is suitable for being rendered on the client and wherein it is determined and transferred from the server; and
means for rendering the second media type content in response to the received second media type content.

In a preferred embodiment of the client, said client further comprises:
means for receiving a first input event;
means for transmitting the first input event to a second software component on the server;
means for receiving a third media type content, wherein the third media type content is transformed and transferred by the second software component, on the server, based on the received first input event and the second media type content; and
means for rendering the third media type content further in response to the received third media type content.

The client provides the same advantages for the same reasons as described previously in relation to the method.

The invention will be explained more fully below in connection with preferred embodiments and with reference to the drawings, in which:

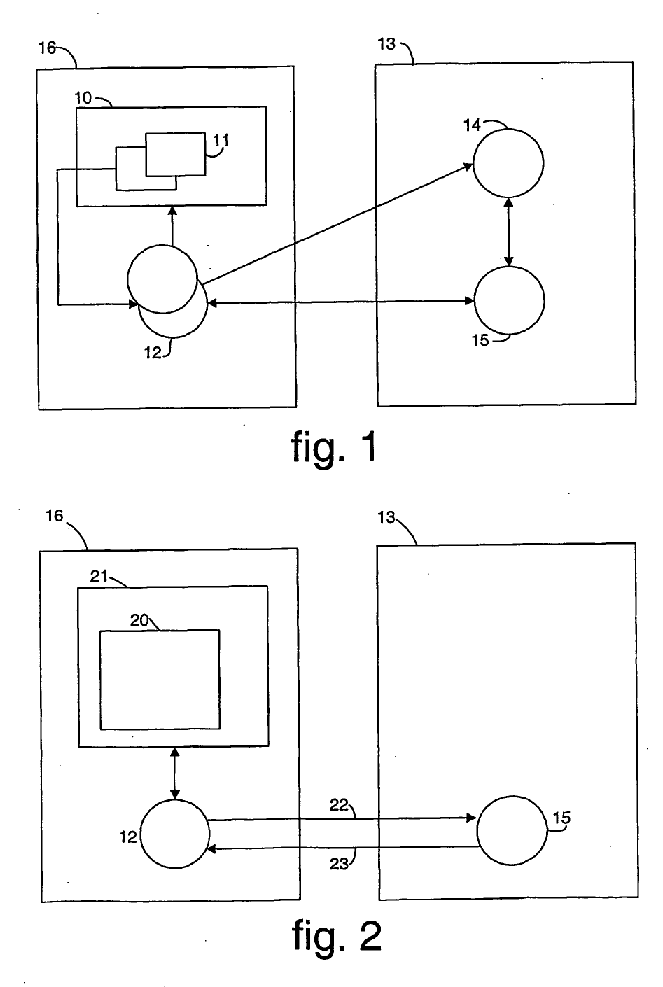

FIG. 1 shows a client server architecture with a basic browser and a first software component on the client and with a second software component and an application manager on the server,

FIG. 2 shows the client server architecture handling input and output functions on a screen area in a parent window on the client;

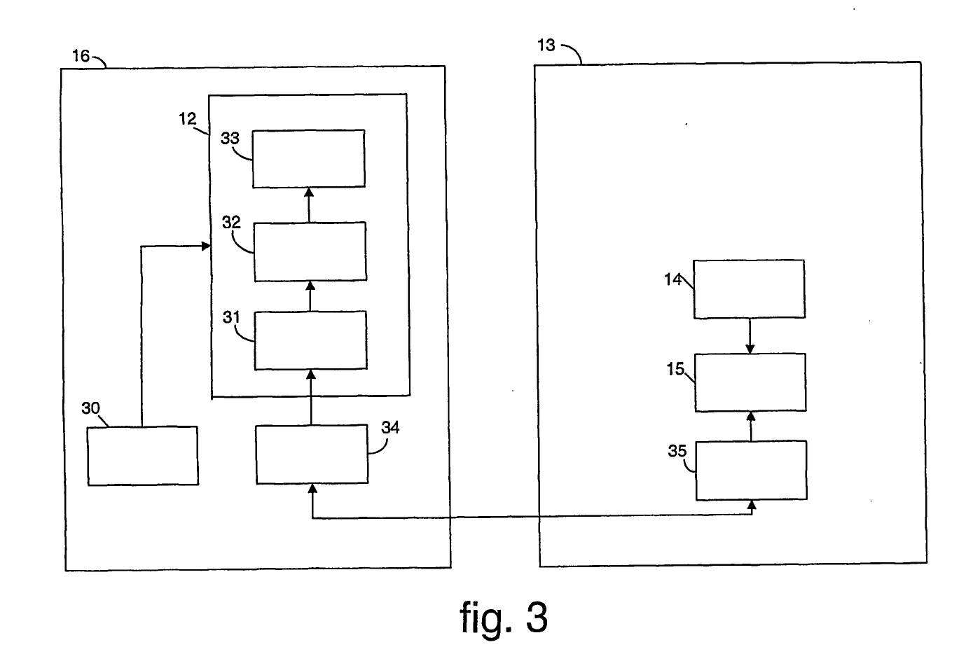

FIG. 3 shows a tree module implementation of the first software component, where the client is configured as a dumb web terminal for the application server; and

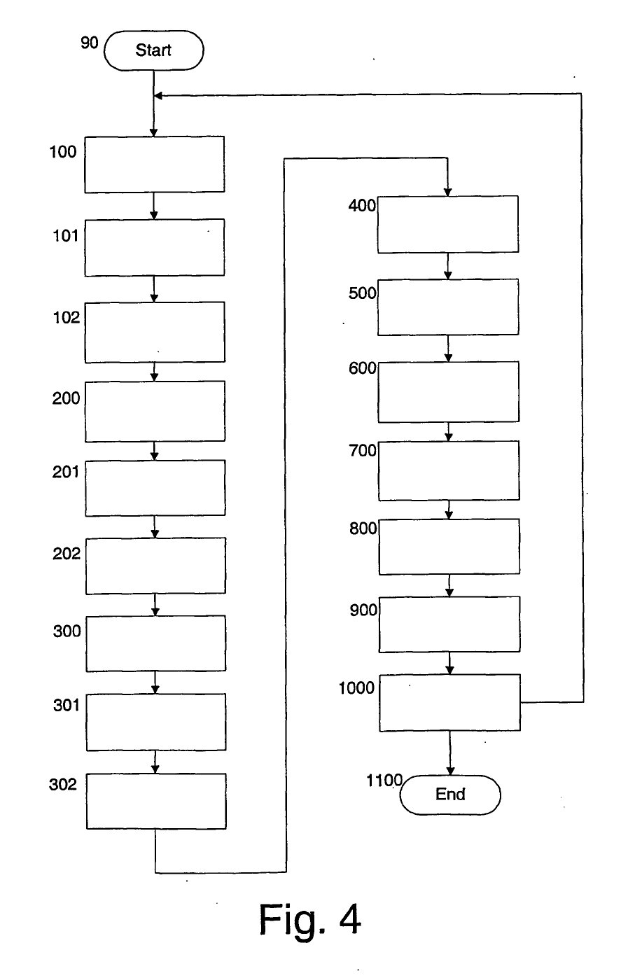

FIG. 4 shows a method of rendering a first media type content on the browser on the client with a rendering support from the server.

Throughout the drawings, the same reference numerals indicate similar or corresponding features, functions, etc.

FIG. 1 shows a client server architecture with a basic browser and a first software component on the client and with a second software component and an application manager on the server. In a preferred embodiment of the invention it is based on an end-to-end client/server architecture, where the client, reference numeral 16, has a basic browser reference numeral 10 with a first software component function enabled. For a browser such as the Netscape Communicator the first software component may be a plug-in installed to the functionality of the basic browser. The basic browser can be any commercial web browser such as Netscape Communicator or Internet Explorer from Microsoft. For Netscape Communicator, the first software component may be implemented by use of a standard plug-in mechanism and with Netscape Communicator as the basic browser, the first software component may be a plug-in as the only plug-in or a default plug-in; conversely—if the said basic browser is the Internet Explorer—the first software component may be implemented by an ActiveX control.

Whenever a user accesses a web site with a media type, reference numeral 11 (for example the PDF, Portable Document Format, or the Word format) that the basic browser cannot handle, i.e. which the basic browser cannot render to the display on the client, the basic browser will activate the first software component, reference numeral 12 to handle the particular media type.

However, the first software component is not the real execution code or executable code for this media type, which means that the first software component can not handle the media type format itself and also does not have rendering capability for this media type. (i.e. the capability to present said media type on said client). Instead, the first software component may act as a so called proxy for this media type. The application server profile (e.g. the IP address of the server) must be known to the first software component. The application server, reference numeral 13 may be installed in a home gateway, in an ISP site, in an ASP site, or in a proxy server.

The first software component may then query the application manager, reference numeral 14, in the application server of reference numeral 13 for rendering support of this media type.

The application manager may then create a second software component as a plug-in application, reference numeral 15 to reside or to be placed on the server for handling of the specific media type. The application server may be any operating system platform that has applications for supporting this media type, as an example the operating system platform of Windows. On the Windows platform there may be an ActiveX control named Web-Browser control, where the client may take advantage of said ActiveX control by hosting it, since this control may act as an Active Document Host, which means that this Web Browser control may load any kinds of software components for rendering any media type (needed, i.e. requested from the client), there may be a software component dedicated to the media type of the Portable Document Format; there may be another software component dedicated to a document or a file created in the Word format, etc. Whenever the second software component, i.e. the plug-in application of reference numeral 15 on the application server site, receives the request for rendering support of a given media type from the first software component, reference numeral 12, the second software component on the server site, reference numeral 15 will access the content of the media type directly from where it resides, i.e. on its corresponding web site(s) or from another server or network drive and decode it, i.e. convert the content of the media type, in the application server site to a renderable, different, simpler format (as opposed to the format of the original content of said media type) dedicated to be presented or rendered on the client.

In addition, by way of hooking window update event, the said second software component may then transfer the content of the renderable, simpler format—e.g. the content may be in the jpeg format—back to the first software component on the client for rendering and or presentation.

Hereby, an originally rather unrenderable (on the client site), complex format such as the Word (.doc format) or the Portable Document Format known from Acrobat Reader (.pdf format), may be converted to a simpler, renderable (on the client site), less complex format, e.g. the JPEG format on the server. Subsequently, the less complex format (or more precisely the content of it) may then be used on the client for rendering and or presentation on the display of the client.

FIG. 2 shows the client server architecture handling input and output functions on a screen area in a parent window on the client. The first software component, reference numeral 12 may—apart from was discussed in the foregoing figure—further handle two basic functions: firstly, an input function (like button click, keyboard entries, etc) from a user of the client, and, secondly, an output function, i.e. displaying which may be understood as presentation or rendering to the display on the client. Whenever the user inputs some commands to the screen area, reference numeral 20 handled by the first software component, the first software component may be notified from the parent window, reference numeral 21. Then the first software component may transmit these input events, reference numeral 22, to the corresponding second software component on the server site. The second software component may transform these input events from the client to specific input events for the application server. The second software component—still on the server site—may then respond to these input events as if these events were generated in the server site. When the second software component notifies that some areas of the screen are to be modified on the client, the second software component may generate output events, reference numeral 23, and may send these output events back to the corresponding first software component, reference numeral 12 on the client site. These output events may be comprised of areas of modified screen data. When the first software component receives output events from the corresponding second software component, reference numeral 15, the first software component may transform these output events and the first software component may then render to the client display. This operation is trasprent to the user of the client, as if the second software component, reference numeral 15—on the server site—code were executed in the client.

As the first software component primarily handles basic I/O events, i.e. to display in a rather simple (i.e. renderable to the client) format and to handle inputs from a keyboard or a mouse, such as button clicks, keyboard entries, etc; the resource requirement for the client in terms of computation power and memory space may be designed to a minimum since said more complex format(s) is/are computed and converted with more computation power and memory space usage on the server site.

FIG. 3 shows a tree module implementation of the first software component, where the client in a preferred embodiment of the invention may be configured as a dumb web terminal for the application server. In this case, the first software component comprises a HTTP sub-module, an XML sub-module and a display sub-module. The HTTP sub-module is shown on the figure by reference numeral 31, the display sub-module by reference numeral 33 and the XML sub-module by reference numeral 32.

The steps of the first software component invocation under this configuration may be as follows:

1. A first software component thread, reference numeral 30 may be used as a main thread on the client, and may query for user's input for browsing or for user's input during the browsing.

2. Whenever the first software component obtains the URL from the user's input, said first software component thread may create the first software component—again with reference numeral 12—with proper size and may pass related information such as the full-URL to the first software component, which then forwards said related information to the application server.

3. After a request from the client, the application manager 14 may create the second software component 15 as a plug-in application for the corresponding first software component.

4. The first software component may then transfer input commands to the second software component (on the server) for using the HTTP sub-module, the second software component may then send back to the first software component the display output commands for rendering on the client.

5. A payload within the HTTP protocol may be encoded in an XML format The XML subs module of the first software component may then interpret and transform to the format renderable for the client.

6. The first software component may then render the output data to the proper area created in step 2 by using the display sub-module.

Said foregoing step 1 may be extended such that the first software component thread pops-up an input dialog box for the user (or pre-defined icons for the user to click on). Whenever the operation of this first software component closes, the thread of the first software component may then terminate automatically.

The communication between the client and the server may be performed by means of a network transport layer, reference numeral 34 on the client side and a corresponding network transport layer, reference numeral 35 on the server side.

FIG. 4 shows a method of rendering a first media type content on the browser on the client with a rendering support from the server.

In step 90, the method is started. Variables, flags, buffers, etc., keeping track of media type and media type content, requests, etc, on the client and the server are set to default states. When the method is started a second time, only corrupted variables, flags, buffers, types etc, are reset to default values.

In step 100, it may be determined if the first media type content is not suitable for being rendered due to limited resources on the client, and—when this is the case—a first software component may then be activated; the first software component (on the client) may thereby be prepared for handling and receiving rendering support from the server. Step 100 constitutes a generalisation of steps 101 and 102. As an example, due to limited resources on the client, i.e. limited processing power, limited amount of RAM, etc, it may not be suitable to render said first media type content by the client itself. Due to said limited resources, the browser on the client may consequently only have corresponding presentation and rendering capabilities.

Said first media type content may be of the type .doc known from Microsoft Word or the type .pdf known from Acrobat, both of these media type may require too much (i.e. processing power, RAM) from the client in order to be rendered. It may therefore—as will be discussed in the following—be more suitable for the client to render the content—basically the same content seen from the user's point of view—based on a simpler type, e.g. the jpeg type.

In step 101, it may be determined by the browser, that the first media type content is not renderable on the client. As discussed in the foregoing step, the said type may not be suitable for being rendered on the client in that it may require too many resources from the client in terms of processing power or RAM, and, if performed—it may take too long and the rendering is therefore not suitable for being performed on the client.

As an example, assume the first media type content is media types such as Adobe Portable Document Format (PDF) or Microsoft Word Document (DOC), the browser on the client would have to take up a large amount of memory resources and is therefore not suitable for being rendered on the browser of the client.

In step 102, if—from the foregoing step—it was determined that said first media type content was not renderable on the client, the browser may activate said first software component on the client. The first software component—when activated—may in the following steps be prepared to handle the rendering/presentation of the content of the media type, when converted to a renderable format, e.g. the jpeg format.

In step 200, the client may transmit a link to the first media type content with a request for rendering support to the server. Step 200 constitutes a generalisation of steps 201 and 202. As a consequence of the foregoing step—and that the client has no resources of its own or does not consider it suitable to use its scarce resources to render itself—it may, generally, ask (request) the server for support so that a subsequent rendering on the client can take place in an appropriate format, i.e.—as the example given—the jpeg type. Any other type than jpeg may be appropriate for the client as long as this other type does not require too much CPU power and or memory capacity on the client, when subsequently rendered. Further to the request, the client may also supply the link to the server, the link may inform the server on which (other) server the content linked to can be found, and subsequently retrieved in step 301.

In step 201, the first software component may transfer the link to the first media type content and the request to an application manager in the server. In more details, as compared to the foregoing step, said link and request may be transferred to said application manager on the server site; hereby the application manager in the server is asked to render support of said first media type from the first software component in the client.

In step 202, the application manager may create the second software component as a plug-in application on the server. The creation may be performed as a response to the reception of the link and the request. Corresponding to the activation of the first software component in step 100, the second software component—as a plug-in application in the server—may be created on the server site in order to be prepared to a later handling of the first media type.

In step 300, the server may determine a second media type content reflecting the received link. Said second media type content may be suitable for being rendered on the client Step 300 constitutes a generalisation of steps 301 and 302. The received link may inform the server on which (other) server the content linked to may be found, and subsequently determine it to another format, i.e. convert it to a second media type content. In other words, in step 300 through 302, the first type content (unrenderable to the client) from the foregoing step is converted to said second media type content, which is then renderable to the client.

In step 301, the second software component may receive a first media type content based on the received link. The received link may inform the server on which (other) server the content linked to can be found and may subsequently retrieve it as the content of the first media type.

In other words, in steps 300 through 302 the server may have accessed the first media type content via the full URL from the link that was sent from the first software component and then the server may subsequently have converted it to the content in the renderable format, i.e. the content of the second media type.

In step 302, the second software component may convert the first media type content to a second media type content on the server. Said first media type content has to be converted to the second media type content that is subsequently renderable on the client. The client and the server may further exchange information regarding which format(s), type(s) the client considers suitable for rendering. Additionally, or alternatively, the server may beforehand be informed which format, i.e. which type or types the client may consider suitable renderable formats. Further, the client and the server may negotiate which formats that need rendering support and vice versa.

In step 400, the server may transfer the second media type content to the client. The transferral may be performed in response to the link and the request received from the client. Here, the second media type content—which, considered from a user's point of view, is similar to the content of the first media type—is transferred to the client.

In step 500, the first software component may render the second media type content on the client. The rendering may be performed when the second media type content is received by the client. Here the client may now—as a consequence of the steps above—render in a suitable format, i.e. in the format of the second media type. It is thereby an advantage of the invention that said steps of the method for accessing web sites on the client is transparent to the user since the user of the client will not notice that the client—as a matter of fact—requested and obtained rendering support from the server.

Of course, said foregoing steps of the method may also apply to content from web sites that do not require any rendering support. In all cases, the user of the client will not perceive any difference between an initially renderable format (step 100, if no support is needed) or a format converted to a renderable format (step 100 through 600, if rendering support was actually needed from the server).

In step 600, the first software component may receive a first input event on the client. As is the case with other devices used to browse the Internet, the user may click with the mouse, operate the keyboard, touch a touch sensible display in order to see or to request further information associated to the information rendered, i.e. displayed on the client. Since—as also discussed in the foregoing—the client may have limited resources in terms of processing power and/or amount of memory cells (RAM, ROM, etc), it may only be suitable for the client to handle very basic functions, and then leave the more complex rendering of the more complex formats and types as well as handling of more resource demanding input and outputs to the server, which may have more processing power and memory cells allocated. Generally in this step, the client receives any input event caused by the use of the mouse, the keyboard, a touching of a touch screen on the client, etc. The input event may—typically—subsequently have the effect that the client display has to show, i.e. to render another content—at least partly.

In step 700, the first software component may send the first input event to a second software component on the server. Similar to step 200—where the link and the request were sent to the server—the first input event representing any use of an input mean on the client, i.e. the mouse, the keyboard, etc, on the client—may be sent to the client by means of the first software component. In other words—with reference to FIG. 2, said first input event, reference numeral 22 is sent to the second software component, reference numeral 15 on the server, reference numeral 13. It may be the case that said first input event further comprises a full-URL of the media content being displayed on the client or another URL embedded in the content displayed. Said first input event may—when considered—indicate that few or more areas of the content being displayed on the client have to be changed, i.e. rendered again.

It may be the case—on the server—that the second software component further comprises a hosting of a Web-Browser control for automatically rendering any supported components under a Windows platform. An advantage of this is that the server may easily compute—as will be discussed in step 800—how the content currently being displayed on the client is affected by said received input event from the client in step 600.

In step 800, the second software component may transform the received first input event to a third media type content on the server. The transformation may be based on the received first input event and content of the second media type already made available and present on the server in step 302. Similar to step 300, the second software component may—in step 800—determine said content of the third media type, the determination may be based on, of course, the first input event and the content currently being displayed on the client, i.e. the second media type content, previously downloaded to the server. In other words, the content of the third media type may therefore represent the result of the old content displayed on the client subsequently affected by said received first input event.

In step 900, the second software component may transfer the third media type content to the first software component on the client.

In step 1000, the first software component may render the third media type content on the client. The rendering may be performed as a response to the reception of the third media type content on the client. Similar to step 500, the first software component may render the received content on the client, but as opposed to step 500, it may be the case that only part or parts of the display need to be rendered anew. Of course, if said first input event originally received by the first software component was a mouse click to a new link, i.e. another URL, the entire display or the screen area on the client, reference numeral 20 in FIG. 2 necessarily will require a full update. In this case step 1000 may be very similar to step 500.

In all of the above mentioned steps where the first software component is used or mentioned, the first software component may be a default plug-in application to the browser on the client, and in this case only a dynamic linkage library of said plug-in may be installed on the client. This may be the case, when the browser, reference numeral 10 of FIG. 1, is Netscape Communicator.

Alternatively, when said browser is Internet Explorer from Microsoft, the first software component may be an ActiveX control.

Further, generally when the first software component or the second software component is mentioned, it may be understood as executable or interpretable code, which may be run, when desired, on the client and the server, respectively.

The client may be an electronic device with access to the Internet and capable of browsing and/or displaying Web-pages and corresponding linked and related content. The client may be a Web tablet, a dumb terminal, a portable device and may further be running a browser with limited allocated resources in term of processing power and/or memory usage. Additionally, the client may be configured as a dumb web terminal for the server.

Usually, the method will start all over again as long as the client and the server are properly exchanging different media type content, requests, etc. Otherwise, the method may terminate in step 1100; however, when the client and the server are powered again, the method may proceed from step 100.

A computer readable medium may be magnetic tape, optical disc, digital video disk (DVD), compact disc (CD record-able or CD write-able), mini-disc, hard disk, floppy disk, smart card, PCMCIA card, etc.

1. A method of rendering a first media type content on a browser on a client with a rendering support from a server, the method comprising the steps of:
determining if the first media type content is not suitable for being rendered due to limited resources on the client and, if this is the case, activating a first software component prepared for handling and receiving rendering support from the server;
transmitting, from the client, a link to the first media type content with a request for rendering support to the server;
determining, on the server, a second media type content of the received link, wherein the second media type content is suitable for being rendered on the client;
transferring, from the server, the second media type content to the client, in response to the received link and the request; and
rendering, by the first software component, the second media type content in response to the received second media type content.

2. A method according to claim 1, characterized in that the method further comprises the steps of:
receiving, by the first software component, a first input event;
transmitting the first input event from the first software component to a second software component on the server;
transforming, by the second software component, the received first input event to a third media type content based on the first input event and the second media type content;
transferring, by the second software component, the third media type content to the first software component; and
rendering, by the first software component, the third media type content further in response to the received third media type content.

3. A method according to claim 2, characterized in that the step of determining comprises:
determining, by the browser, that the first media type content is not renderable on the client; and
activating, if this is the case, the first software component by the browser.

4. A method according to claim 3, characterized in that the step of sending from the client comprises:
transferring, by the first software component, the link to the first media type content and the request to an application manager in the server; and
creating, by the application manager, the second software component as a plug-in application in response to the received link and request.

5. A method according to claim 4, characterized in that the step of determining, on the server a second media type content of the received link comprises:
receiving, by the second software component, a first media type content based on the received link; and
converting, by the second software component, the first media type content to a second media type content.

6. A method according to claim 5, characterized in that the first software component is a default plug-in application, wherein only a dynamic linkage library of the default plug-in application is installed on the client.

7. A method according to claim 5 characterized in that the first software component is an ActiveX control.

8. A method according to claim 7, characterized in that the first software component comprises a HTTP sub-module, a XML sub-module and a display sub-module, whereby the client is a dumb terminal.

9. A computer system for performing the method according to claim 1.

10. A computer program product comprising program code means stored on a computer readable medium for performing the method of claim 1 when the computer program is run on a computer.

11. A client for rendering a first media type content on a browser with a rendering support from a server comprising:
means for determining if the first media type content is not suitable for being rendered due to limited resources and, if this is the case, activating a first software component prepared for handling and receiving rendering support from the server;
means for transmitting a link to the first media type content with a request for rendering support to the server;
means for receiving a second media type content of the transmitted link, wherein the second media type content is suitable for being rendered on the client and wherein it is determined and transferred from the server; and
means for rendering the second media type content in response to the received second media type content.

12. A client for rendering a first media type content on a browser with a rendering support from a server according to claim 11 further comprising:
means for receiving a first input event;
means for transmitting the first input event to a second software component on the server;
means for receiving a third media type content, wherein the third media type content is transformed and transferred by the second software component, on the server, based on the received first input event and the second media type content; and
means for rendering the third media type content further in response to the received third media type content.
